(19) United States
(12) Patent Application Publication
(10) Pub. No.: US 2004/0241865 A1
(43) Pub. Date: Dec. 2, 2004

(54) Method and device for the process-attendant cleaning of micro-and mini-reactors

(76) Inventors: Hans-Peter Gabski, Alsbach-Haehnlein (DE); Ruediger Winter, Kelkheim (DE); Christian Wille, Weinheim (DE)

Correspondence Address: CLARIANT CORPORATION, INTELLECTUAL PROPERTY DEPARTMENT, 4000 MONROE ROAD, CHARLOTTE, NC, 28205, US

(21) Appl. No.: 10/488,644

(22) PCT Filed: Aug. 23, 2002
(86) PCT No.: PCT/EP02/09440

(30) Foreign Application Priority Data
Sep. 4, 2001 (DE) 101 43 489.9

(51) Int. Cl. G01N 35/02

(52) U.S. Cl. 436/49

(57) ABSTRACT

The invention is directed to cleaning of micro- and mini-reactors for controlled process management and for avoiding blockages on carrying out chemical reactions and physical processes. The invention is characterized in that the micro- or mini-reactor is cleaned by means of a controlled pressure increase with a subsequent sudden release or with a gas pressure surge in a cyclical manner or using a controller. Wall deposits formed from solid material(s) involved in the chemical synthesis or the physical process are thus almost completely removed such that, after the cleaning procedure, the initial operating pressure can be set in the micro- or mini-reactor. A blockage of the micro- or mini-reactor can thus be avoided and the transferring of said production method to the production scale with micro- or mini-reactors is possible for the first time. The above is particularly true for reactions in which educts in the form of suspensions are used and/or solid products arise, such as in the production of azo dyes, for example.

Chemical reactions and physical processes conducted in micro- and minireactors having channel dimensions in the submillimeter range and in the millimeter range respectively often give rise to the problem of fouling or even clogging. This holds especially for reactions which utilize reactants in the form of suspensions and/or give rise to solid products, such as the synthesis of azo colorants for example. Fouling due, for example, to sedimentation, adsorption or crystallization of solid products has a lasting adverse impact on throughput and metering accuracy of reactants so that defined reaction conditions, such as use concentrations for example, cannot be maintained and significant advantages of using micro- or minireactors are lost. Fouling may also lead to clogging of the micro- or minireactor.

Passive cleaning measures, for example coating the wetted areas in the micro- or minireactor with anti-adhesives, is in most cases not an option because of chemical interaction of these auxiliary materials with reactants. Moreover, coating quality and consistency is very difficult to police in microreactors, for example in sandwich construction, the various modules of which are normally joined to each other by integral bonding.

Experimental studies relating to the synthesis of certain azo colorants have produced the following results with regard to fouling in a microreactor:

At throughputs up to 100 ml/min, the pressure rises from 0.5 bar to 6 bar as a consequence of fouling of the microchannels with solid product following prolonged operation, and may even entail a direct outage of pumps when the maximum pumping pressure is reached.

Observations at throughputs of 500 ml/min were similar, except that higher pressures were reached as a consequence of higher pumping pressure: starting at 0.5 bar the pressure initially rises exponentially until, after attainment of a local pressure maximum, this can be up to 20 bar or even higher, it briefly falls back down to a local minimum—albeit not all the way back to the initial pressure of 0.5 bar—only then to rise again exponentially. The fact that the initial pressure level of 0.5 bar is not reached in any of the cases indicates that fouling was only partially removed. Controlled process management is difficult when the average operating pressure constantly rises, falls again and the pressure fluctuations and also the magnitudes of the local maxima and minima are subject to statistical fluctuations. It is therefore an object of the present invention to provide a process for cleaning micro- and minireactors which for cost reasons has to take place during operation, i.e., in-process. Any fouling of reaction channels thus has to be specifically removed during the ongoing process. To ensure controlled process management and exclude the possibility of micro- or minireactor clogging, the pressure drop in the micro- or minireactor may only vary controllably within predetermined limits. Furthermore, the process shall not require the use of additives.

It is a further object of the present invention to provide a suitable apparatus and also an open and closed loop control concept for conducting the process.

In-process cleaning to ensure controlled process management has hitherto not been known for micro- or minireactors, either on a laboratory scale or on a pilot plant scale.

It was found that this object is surprisingly achieved by deliberately inducing sudden positive or negative flow rate or pressure changes during the ongoing chemical or physical process in the micro- or minireactor.

The present invention provides a process for in-process cleaning of micro- and minireactors, characterized in that a single or multiple abrupt change in the flow rate, pressure and/or viscosity of the flowing medium is brought about in a controlled manner during an ongoing chemical or physical process in the micro- or minireactor.

The attendant alternating exposure of the fouling film surface to shearing forces surprisingly produces not partial but substantially complete removal of the fouling film in that the pressure in the micro- or minireactor returns to its original operating level after the cleaning operation.

This provides mechanical detachment not only of sediments which are coarsely crystalline in nature but also of resistant fouling deposits which have their origin in adsorption and subsequent crystallization processes of dispersed finely to very finely particulate chemical compounds, for example pigment particles ranging in grain size from a few hundred nanometers to a few micrometers.

The process of the present invention can be carried out in two preferred versions:

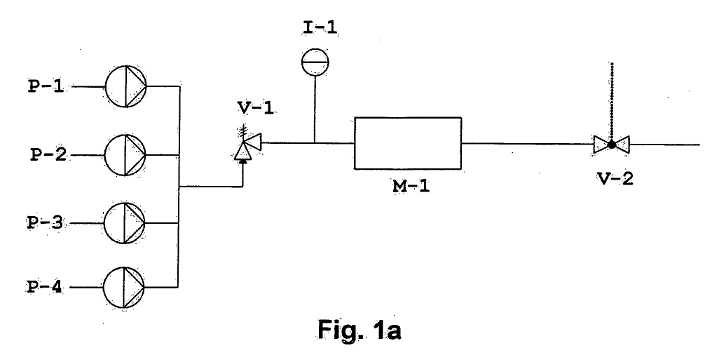

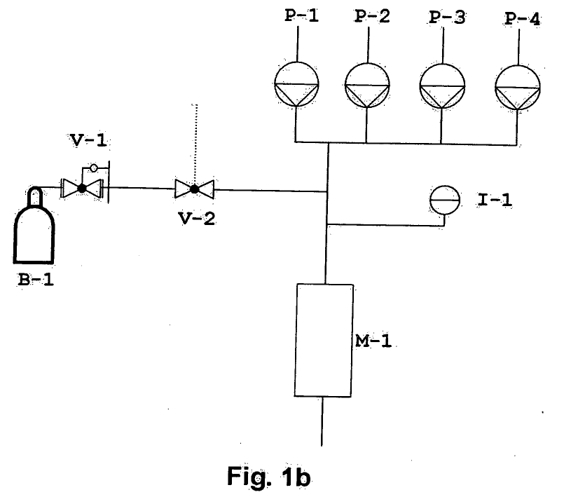

a) In the first version, the initial step is for a high pressure to be built up in a controlled manner that is suddenly released. This is accomplished by means of actuatable throttling or blocking means (a valve being an example) upstream or downstream of the micro- or minireactor (see FIG. 1a).

On attaining a system-specific limiting value for the operating pressure, for example 10 to 20 bar, the upstream or downstream throttling or blocking means is closed and on attainment of a pressure which is for example 0.5 to 500 bar above this limiting value, preferably at the maximum permissible overall pressure of the apparatus, for example 50 bar, the upstream or downstream throttling or blocking means is reopened at a stroke. As a result, the micro- or minireactor interior experiences initially a pressure increase with subsequent sudden depressurization and a consequent cavitation effect. This positive and negative change in flow rate or pressure and the attendant alternating exposure of the fouling film surface to shearing forces surprisingly leads to almost complete removal of the fouling, so that the pressure in the micro- or minireactor returns to its original value, for example 0.5 to 5 bar, after the cleaning operation.

b) In the second version, a pressure pulse of an inert gas is introduced via a T-piece in the pressure line upstream of the micro- or minireactor (see FIG. 1b).

On attainment of a certain limiting value for the operating pressure, for example 10 to 20 bar, the throttling or blocking means (a valve being an example) connected to gas supply means is briefly (for example for about 0.5 to 2 s) opened and immediately reclosed in succession one or more times. In the process, an inert gas, nitrogen for example, is fed via a pressure control system into the pressure line at an admission pressure (5 to 500 bar for example) which is adapted to the maximum permissible total pressure in the micro- or minireactor. This gives rise in the micro- or minireactor to a sudden gas pressure pulse with superposed change in media, i.e., a sudden change in viscosity. The medium which flows prior to the increase in pressure is the reaction mixture, it is gas during the pressure pulse at a very high speed of a few m/s and thereafter again the reaction mixture. This positive and negative change in flow rate or pressure, the additional sudden change in viscosity by a few orders of magnitude and the attendant alternating exposure of the fouling film surface to shearing forces surprisingly lead to almost complete removal of fouling, so that the pressure in the micro- or minireactor returns to its original value, for example 0.5 to 5 bar, after the cleaning operation.

Both the versions of the cleaning process described utilize pressure pulses which vary as a function of viscosity and media and as a function of the operating pressure of the micro- or minireactor between 0.5 and 500 bar, preferably between 0.5 and 250 bar and more preferably between 0.5 and 160 bar.

The invention also provides a combination of versions a) and b).

The inducing of the cleaning procedure, i.e., the opening and closing of the throttling or blocking means in versions a) and b) of the inventive process, is advantageously controlled open-loop via a repeating chronological sequence or closed-loop and on-line.

Under open-loop control, the cleaning procedure is preferably undertaken in a defined cycle by means of a specified time all-or-nothing element, irrespectively of whether any pressure increase has occurred in the micro- or minireactor as a consequence of fouling. The most advantageous cycle is dependent on the type of chemical reaction or of the physical process and has to be determined experimentally. It was found, for example, that the pressure in the microreactor will exceed a limiting value of 30 bar in a cycle of about 30 min for the synthesis of Pigment Yellow 191. Cyclic cleaning of the microreactor at 15 min intervals made it possible to carry out the manufacturing process for 12 h without fouling, but especially without clogging of the microreactor.

Under on-line closed-loop control, the operating pressure in the micro- or minireactor is recorded on-line and the cleaning operation is not initiated until a system-specific limiting value is exceeded. This version requires a closed-loop control system which compares the current operating pressure in the micro- or minireactor with the limiting value and initiates cleaning if and when the limiting value is reached.

In practice, the normal approach is initially only to record the pressure on-line at an experimental stage of the process to be investigated. A sustained use test is then carried out for some hours to see whether the micro- or minireactor cleans itself and at what level, if any, an average operating pressure becomes established. The cleaning cycle (for the open-loop control version) or the pressure limiting value (for the closed-loop version) is decided as a function of the pressure course determined.

The inventive cleaning process can sensibly be applied to all chemical reactions or physical processes in micro- or minireactors which utilize reactants in the form of suspensions and/or give rise to products in solid form. The inventive process is particularly preferred for the synthesis or an elementary step of the synthesis of an organic pigment.

Preferred chemical reactions for the purposes of the present invention are: azo coupling reaction, laking and/or metal complexation for preparing azo colorants, especially azo pigments, as described in DE-A-100 05 550; azo coupling, acyl chloride formation and condensation of disazo condensation pigments as described in still unpublished German patent application 100 32 019.8; reaction of succinic diesters with nitrites and subsequent hydrolysis to prepare 1,4-diketopyrrolo(3,4-c)pyrrole pigments as described in still unpublished German patent application 100 28 104.4.

Examples of azo pigments which are advantageously prepared by the process according to the present invention are C.I. Pigment Yellow 1, 3, 12,13, 14,16, 17, 65, 73, 74, 75, 81, 83, 97, 111, 120, 126, 127, 151, 154,155,174,175, 176,180, 181, 183, 191,194, 198; Pigment Orange 5, 34, 36, 38, 62, 72, 74; Pigment Red 2, 3, 4, 8, 12,14, 22, 48:1-4, 49:1, 52:1-2, 53:1-3, 57:1, 60:1, 112, 137, 144, 146, 147,170, 171,175,176, 184,185, 187, 188,208, 214, 242, 247, 253, 256, 266; Pigment Violet 32; Pigment Brown 25.

Preferred physical processes for the purposes of the present invention are conditionings of organic pigments by thermal treatment of liquid prepigment suspensions in micro- or minireactors as described in still unpublished German patent application 100 31 558.5.

The invention also provides an apparatus for in-process cleaning of micro- and minireactors, version a) being advantageously carried out using an apparatus as per FIG. 1a, comprising a micro- or minireactor (M-1) connected to pumps and pressure lines, a downstream throttling or blocking means, here shown as a control valve (V-2), and a pressure transmitter (I-1).

The reactants are metered into the micro- or minireactor (M-1) by one or more pumps (e.g., P-1, P-2, P-3, P-4). A pressure transmitter (I-1) indicates the current operating pressure in the reaction channels. The values are compared with the limiting operating pressure previously determined by experiment. On exceedance of the limiting operating pressure the downstream control valve (V-2) is closed and kept closed until the maximum permissible operating pressure in the reactor (M-1) is reached. Then, the control valve is suddenly reopened. An overflow valve (V-1) upstream of the microreactor ensures that no impermissible total pressure is reached in the microreactor in the event of an outage of the control valve (V-2).

Version b) is advantageously carried out using an apparatus as per FIG. 1b, characterized by a micro- or minireactor (M-1) connected to pumps, pressure lines, gas supply means (B-1) and gas throttling and blocking means, for example valves in this instance, (V-1, V-2) and by a pressure transmitter (I-1).

The reactants are metered into the micro-/minireactor (M-1) by one or more pumps (e.g., P-1, P-2, P-3, P4). A pressure transmitter (I-1) indicates the current operating pressure in the reaction channels.

The gas pressure pulse is effected via the valve (V-2) which is controllable from the pressure side and which is opened for a short period, preferably 0.1 to 2 seconds, and closed again. The magnitude of the gas pressure pulse from the gas supply means (B-1) is preferably pre-fed via a control valve (V-1).

It will be appreciated that an apparatus as per FIG. 1a) can be combined with an apparatus as per FIG. 1b) by installing in the apparatus as per FIG. 1b) a further control valve upstream or downstream of the reactor.

Customary micro- and minireactors can be used, especially those having flow cross sections in the micro- to millimeter range. Microreactors are preferred. Suitable microreactors are described for example in DE-A-1 000 5550.

A microreactor is constructed for example from a plurality of laminae which are stacked and bonded together and whose surfaces bear micromechanically created structures which cooperate to form reaction spaces for chemical reactions. The system contains at least one continuous channel connected to the inlet and the outlet.

The flow rates of streams of material are limited by the apparatus, for example by the pressures which result depending on the geometry of the microreactor. The flow rates are advantageously between 0.05 and 5 l/min, preferably between 0.05 and 500 ml/min, more preferably between 0.05 and 250 ml/min and especially between 0.1 and 100 ml/min.

When an azo coupling reaction is to be carried out, it is also possibile to connect the micro- or minireactor to a downstream flow-through measuring cell for continuous redox control, as described in the still unpublished German patent application 101 08 716.0.

### EXAMPLE

A modular microreactor in sandwich construction having an internal degree of parallelization of 6 was used, i.e., the reactants—subdivided into sub-streams—are simultaneously mixed and reacted in 6 parallel modules. These mixing and reaction modules are housed in sandwich fashion together with heat exchangers which not only preheat the feedstocks but additionally temperature-control the reaction sector.

In-process cleaning of a microreactor used for coupling Pigment Yellow 191.

Preparation of Diazonium Salt Solution:

5.66 kg (25 mol; w=98%) of 2-amino-4-chloro-5-methylbenzenesulfonic acid are dissolved in 50 kg of water by addition of (25.5 mol; 33% strength) aqueous sodium hydroxide solution and heating. The solution is clarified and precipitated with 31% HCl. Ice is used to cool to 15° C. and the diazotization is carried out with 4.31 kg (25 mol; 40% strength) of sodium nitrite solution. After supplementary stirring for an hour, water is added to make up to 187.5 kg (final concentration: 0.133 mol/kg).

Dissolving Pyrazole Acid (Coupling Component):

50 kg of water are charged to a dissolving vessel and 8.64 kg (25 mol; M=254.3 g/mol; 73.6%) of 1-(3′-sulfophenyl)-3-methyl-5-pyrazolone are added. The mixture is admixed with 3.79 kg (31.1 mol; 33% by weight strength) of aqueous sodium hydroxide solution by stirring and supplementarily stirred for 15 min, and the solution is heated to 40° C. and supplementarily stirred for a further 30 min. Finally, the solution is made up with water to 93.75 kg (final concentration: 0.233 mol/kg).

Setting of Swing Liquor:

43.94 kg of water are stirred up with 6.06 kg (50 mol; 33% by weight strength) of aqueous sodium hydroxide solution.

Coupling in the Microreactor with In-Process Cleaning:

The microreactor has metered into it under coupling conditions (pH 6.3, T=45° C.)

diazo suspension (13 l/h),

coupling component (6.8 l/h),

swing liquor (3.6 l/h) and

water (11.6 l/h).

Preliminary investigations have shown that the operating pressure adjusts to a base value of about 0.5 bar when coupling Pigment Yellow 191 under the reaction conditions mentioned and also under the chosen volume flow rates for the reactants. As the reaction channels gradually become fouled up, the operating pressure in the microreactor rises in the course of a cycle of about 30 min up to 10 bar—in isolated cases even up to 30 bar or more—until, as a consequence of microreactor self-cleaning, the pressure decreases back down to a local minimum, but not to the base level of about 0.5 bar.

To ensure controlled process management, the microreactor is cleaned in-process during the manufacturing operation:

a): In-process cleaning of the micro-/minireactor with controlled pressure increase and subsequent sudden depressurization of the reaction mixture:

An open-loop control system is pre-set with 10 bar as a limiting value for the maximum pressure in the microreactor. As soon as this limiting value is reached as a consequence of fouling of the reaction channels in the microreactor, the valve is actuated and closed until a pressure in the microreactor adjusts to the permissible total pressure in the microreactor (50 bar). Then the valve is suddenly opened. The operating pressure in the microreactor subsequently comes back down to its original value of 0.5 bar.

Scenario b): In-process cleaning of the micro-/minireactor by means of gas pressure pulse:

A specified time all-or-nothing element is used to initiate, in a 15 min cycle, upstream of the microreactor a pressure pulse of gaseous nitrogen through briefly opening an actuatable valve for 0.1 to 2 seconds in such a way that a pressure pulse in the magnitude of the permissible total pressure in the microreactor (50 bar) becomes established in the microreactor. Then the valve is closed again. The operating pressure in the microreactor then comes back down to its original value of 0.5 bar.

What is claimed is:

1) A process for in-process cleaning of micro- and minireactors, comprising the steps of increasing the pressure upstream or downstream of the micro- or minireactor from a first pressure to a second pressure, wherein the second pressure is between 0.5 and 500 bar and reducing the pressure upstream or downstream of the micro- or minireactor from the second pressure to the first pressure, wherein the process occurs during an ongoing chemical or physical process in the micro- or minireactor.

2) A process according to claim 1, wherein the increasing and reducing steps are repeated at regular chronological intervals.

3) A process according to claim 1, wherein the micro- or minireactor has an operating pressure, and wherein the increasing step is performed when the operating pressure has reached a predetermined limiting value.

4) A process according to claim 9, wherein the micro- or minireactor has a gas supply line upstream thereof and the introducing step further comprises introducing the pressure pulse into the gas supply line.

5) A process according to claim 9, wherein the micro or minireactor has an operating pressure and wherein the introducing step is performed when the operating pressure has reached a predetermined limiting value.

6) A process according to claim 1, wherein the chemical process is the synthesis or an elementary step in the synthesis of an organic pigment.

7) A process according to claim 1, wherein the physical process is the thermal treatment of a prepigment suspension.

8) A process for in-process cleaning of micro- and minireactors comprising the step of altering at least one flow medium characteristic during an ongoing chemical or physical process the micro- or minireactor, wherein the at least one flow medium characteristic is selected from the group consisting of flow rate, pressure and viscosity.

9) A process for in-process cleaning of micro- and minireactors, comprising the step of introducing at least one pressure pulse of inert gas upstream of the micro or minireactor, wherein the process occurs during an ongoing chemical or physical process in the micro or minireactor.

10) A process according to claim 9, wherein the chemical process is the synthesis or an elementary step in the synthesis of an organic pigment.

11) A process according to claim 1, wherein the chemical process in an azo coupling reaction.

12) A process according to claim 9, wherein the chemical process is an azo coupling reaction.

13) A process according to claim 9, wherein the physical process is the thermal treatment of a prepigment suspension.
